(19) United States
(12) Patent Application Publication
(10) Pub. No.: US 2024/0155564 A1
(43) Pub. Date: May 9, 2024

(54) RESOURCE SELECTION METHOD, RESOURCE SELECTION DEVICE AND STORAGE MEDIUM

(71) Applicant: BEIJING XIAOMI MOBILE SOFTWARE CO., LTD., Beijing (CN)

(72) Inventor: Wensu ZHAO, Beijing (CN)

(73) Assignee: BEIJING XIAOMI MOBILE SOFTWARE CO., LTD., Beijing (CN)

(21) Appl. No.: 18/284,065

(22) PCT Filed: Mar. 25, 2021
(86) PCT No.: PCT/CN2021/083023

§ 371 Date: Sep. 25, 2023

(51) Int. Cl. H04W 72/02; H04W 72/0446; H04W 72/563

(52) U.S. Cl. CPC H04W 72/02; H04W 72/0446; H04W 72/563

(57) ABSTRACT

The present disclosure relates to a resource selection method, a resource selection device and a storage medium. The resource selection method comprises: determining a first moment and a first time interval; determining a second moment on the basis of the first moment and the first time interval, the second moment being at the first time interval from the first moment; and taking the second moment as a starting moment of a first device for resource selection, or a starting moment of a resource selection window of the first device.

### CROSS REFERENCE

The present application is a U.S. National Stage of International Application No. PCT/CN2021/083023, filed on Mar. 25, 2021, the contents of which are incorporated herein by reference in their entireties for all purposes.

### BACKGROUND

Since Long Term Evolution (LTE), the Third Generation Partnership (3GPP) has been formulating the Sidelink standard as a standard for end-to-end direct communication. In July 2020, the first standard of New Radio (NR) Sidelink was completed in Rel-16. The solution of NR Sidelink is mainly used for vehicle to everything (V2X) and public safety. For V2X and public safety, due to time constraints, Release16 does not fully support service requirements and operation plans, and Service and System Aspects (SA) make some enhancements in Release17 NR Sidelink, such as architecture enhancement and system enhancement for 3GPP to support advanced V2X services. Furthermore, in the SA working group, other commercial cases related to NR Sidelink are being studied, such as network-controlled interactive services, enhanced energy efficiency relays, wide coverage, audiovisual service production. Therefore, in the 86th Plenary Session of 3GPP, the enhancement of NR Sidelink was included as a work item in the Release 17 project, with the purpose of enhancing the reliability of Sidelink transmission and reducing latency.

In the enhancement of NR Sidelink, user equipment A for direct communication can send a resource set to user equipment B whose resource selection mode is Mode2. User equipment B takes it into consideration when performing resource selection for its own data transmission. That is, user equipment can use an auxiliary mechanism for resource selection.

### SUMMARY

The present disclosure relates to the field of communication technologies and, in particular, to a resource selection method, a resource selection device, and a storage medium. The present disclosure provides a resource selection method, a resource selection device, and a storage medium.

According to a first aspect of the present disclosure, there is provided a resource selection method, applied to a first device, and the resource selection method including: determining a first moment and a first time interval; determining a second moment based on the first moment and the first time interval, wherein the second moment is separated from the first moment by the first time interval; and serving the second moment as a starting moment for resource selection by the first device, or a starting moment of a resource selection window of the first device.

According to a second aspect of the present disclosure, there is provided a resource selection device, including:
a processing unit, configured to determine a first moment and a first time interval, and determine a second moment based on the first moment and the first time interval, wherein the second moment is separated from the first moment by the first time interval, and serve the second moment as a starting moment for resource selection by the first device, or a starting moment of a resource selection window of the first device.

According to a third aspect of the present disclosure, there is provided a resource selection device, including: a processor; a memory for storing instructions executable by the processor; wherein, the processor is configured to execute the resource selection method according to the first aspect or any embodiment of the first aspect.

According to a fourth aspect of the present disclosure, there is provided a non-transitory storage medium, having instructions stored therein, wherein the instructions in the storage medium enable a mobile terminal to execute the resource selection method according to the first aspect or any embodiment of the first aspect, when executed by a processor of the mobile terminal.

It should be understood that the above general description and the following detailed description are only exemplary and explanatory and do not limit the present disclosure.

### BRIEF DESCRIPTION OF THE DRAWINGS

The accompanying drawings, which are incorporated in and constitute a part of this specification, illustrate embodiments consistent with the disclosure and together with the description serve to explain the principles of the disclosure.

FIG. 1 is a schematic diagram of a direct communication system according to an example of the present disclosure.

FIGS. 2A and 2B show a schematic diagram of using an auxiliary mechanism for resource selection between UEs in an example of the present disclosure.

FIG. 3 shows a schematic diagram of resource selection without using an auxiliary mechanism according to an example of the present disclosure.

FIG. 4 is a flow chart showing a resource selection method according to an example of the present disclosure.

FIG. 5 shows a schematic diagram of resource selection in an example embodiment of the present disclosure.

FIG. 6 shows a schematic diagram of resource selection in an example of the present disclosure.

FIG. 7 shows a schematic diagram of resource selection in an example of the present disclosure.

FIG. 8 shows a flow chart of a resource selection method in an example of the present disclosure.

FIG. 9 shows a schematic diagram of corresponding values among the ΔT value, priority and PDB value shown in an example of the present disclosure.

FIG. 10 is a block diagram of a resource selection device according to an example of the present disclosure.

FIG. 11 is a block diagram of a resource selection device according to an example of the present disclosure.

### DETAILED DESCRIPTION

Reference will now be made in detail to the examples illustrated in the accompanying drawings. When the following description refers to the drawings, the same numbers in different drawings refer to the same or similar elements unless otherwise indicated. The implementations described in the following example do not represent all implementations consistent with the present disclosure. Rather, they are merely examples of devices and methods consistent with aspects of the disclosure as detailed in the appended claims.

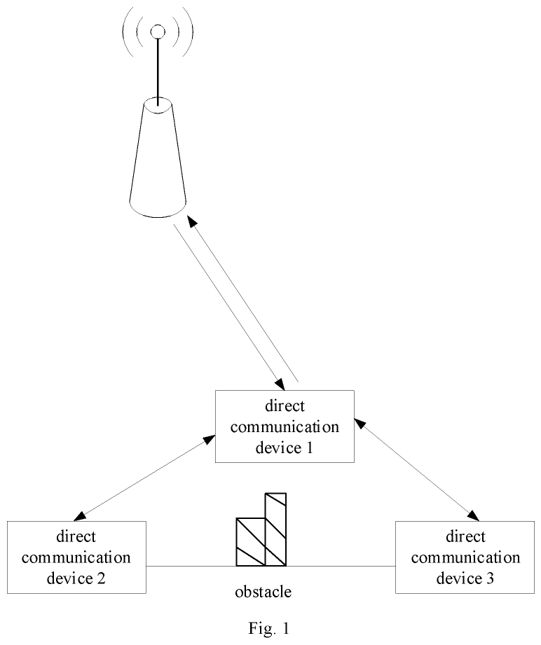

The resource selection method provided by the examples of the present disclosure can be applied to the direct communication system shown in FIG. 1. Referring to FIG. 1, in a scenario where direct communication is performed between direct communication devices, the network device configures various transmission parameters for data transmission for the direct communication device 1. The direct communication device 1, the direct communication device 2 and the direct communication device 3 perform direct communication. There may be obstacles between the direct communication device 2 and the direct communication device 3. The link for communication between the network device and the direct communication device is an upstream and downstream link, and the link between the direct communication device and the direct communication device is a direct link (sidelink).

In the present disclosure, the communication scenario of direct communication between direct communication devices may be a vehicle wireless communication technology (Vehicle to Everything, V2X) business scenario. In the examples disclosed herein, V represents the vehicle-mounted device, and X represents any object that interacts with the vehicle-mounted device. Currently, X mainly includes vehicle-mounted devices, handheld devices, traffic roadside infrastructure and networks. The information modes of V2X interaction include: interaction between Vehicle to Vehicle (V2V), Vehicle to Infrastructure (V2I), Vehicle to Pedestrian (V2P), and Vehicle to Network (V2N).

With the development of the new generation of 5G mobile communication technology, 5G NR technology is used in 3GPP Rel-16 to support new V2x communication services and scenarios, such as Vehicles Platooning, Extended Sensors, Advanced Driving, and remote driving, etc. Generally speaking, 5G V2x sidelink can provide higher communication rate, shorter communication delay, and more reliable communication quality.

The communication scenario of direct communication between direct communication devices can also be a Device to Device (D2D) communication scenario. The direct communication devices for direct communication in the examples of the present disclosure may include various handheld devices with wireless communication functions, vehicle-mounted devices, wearable devices, computing devices or other processing devices connected to wireless modems, as well as various forms of user Equipment (UE), Mobile station (MS), terminal, Terminal Equipment, etc. For convenience of description, the examples of the present disclosure will be described below by taking the direct communication device as the user equipment as an example.

The enhancement of NR Sidelink can improve transmission reliability and reduce latency. In the enhancement of NR Sidelink, in terms of enhancing Mode2 resource allocation, the 3GPP working group reached a conclusion that it is necessary to study a manner for assisting resource selection among UEs. In this manner, two UEs are specified. For example, user equipment A is auxiliary user equipment of user equipment B, and user equipment B refers to the user equipment that needs to perform resource selection for data sent by itself. The user equipment A will determine a resource set, and send it to user equipment B through mode 2, and user equipment B will consider the resource set sent by user equipment A when performing resource selection.

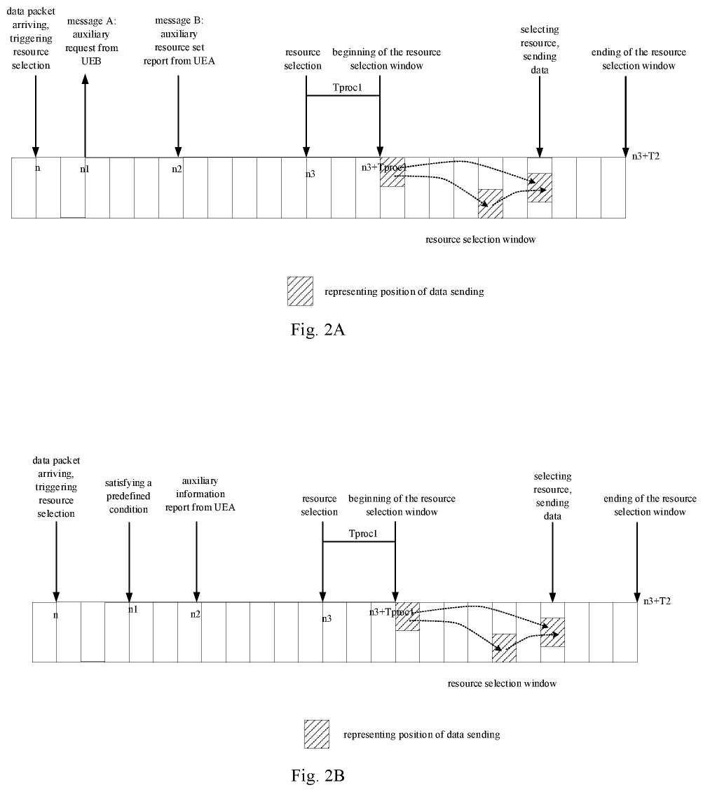

FIGS. 2A and 2B show a schematic diagram of using an auxiliary mechanism for resource selection between UEs according to an example of the present disclosure. Referring to FIGS. 2A and 2B, UEA is auxiliary UE of UEB, and may also be receiving UE. In the related technology, the following two manners can be used to trigger resource selection between UEs by using the auxiliary selection resource manner. In one manner, as shown in FIG. 2A, the UEB sends an auxiliary request to the UEA, requesting the UEA to send the auxiliary resource information to the UEB. In another manner, as shown in FIG. 2B, after the predefined condition is met, the UEA sends the auxiliary resource information to the UEB.

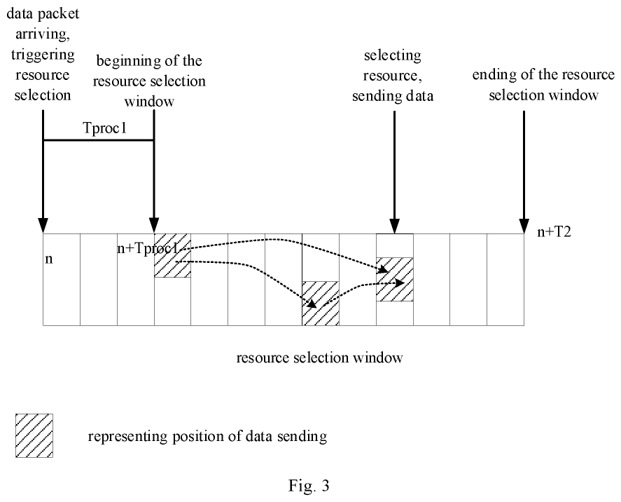

However, when no auxiliary mechanism is used for resource selection, resource selection will be triggered when the data packet arrives during the resource selection process of Mode2. FIG. 3 shows a schematic diagram of resource selection without using an auxiliary mechanism. Referring to FIG. 3, at the time of n when the data packet arrives, resource selection is triggered and resource selection begins. However, referring to the above-mentioned FIGS. 2A and 2B, when the auxiliary mechanism is used for resource selection, after the data packet arrives and the resource selection is triggered, the resource selection will not start immediately, but the process of inter-device assistance will start. Therefore, when the auxiliary mechanism is used for resource selection, it will cause a delay in the start position of the resource selection window, which will bring a certain delay. At the same time, with respect to assistance between devices, there is also the exchange of signaling between devices, which also brings a certain delay. However, the sidelink goal of R17 is low latency, so a technical solution needs to be designed to reduce the latency of assistance between devices.

In view of this, an example of the present disclosure provides a resource selection method. In the resource selection method, when an auxiliary mechanism is used for resource selection, the starting moment for resource selection is restricted, that is, after the restricted time arrives, the resource selection must be performed. Therefore, resource selection based on this restricted time can reduce the delay caused by using an auxiliary mechanism for resource selection.

In the examples of the present disclosure, for convenience of description, a device that performs resource selection is referred to as a first device, and a device that assists the first device in resource selection is referred to as a second device.

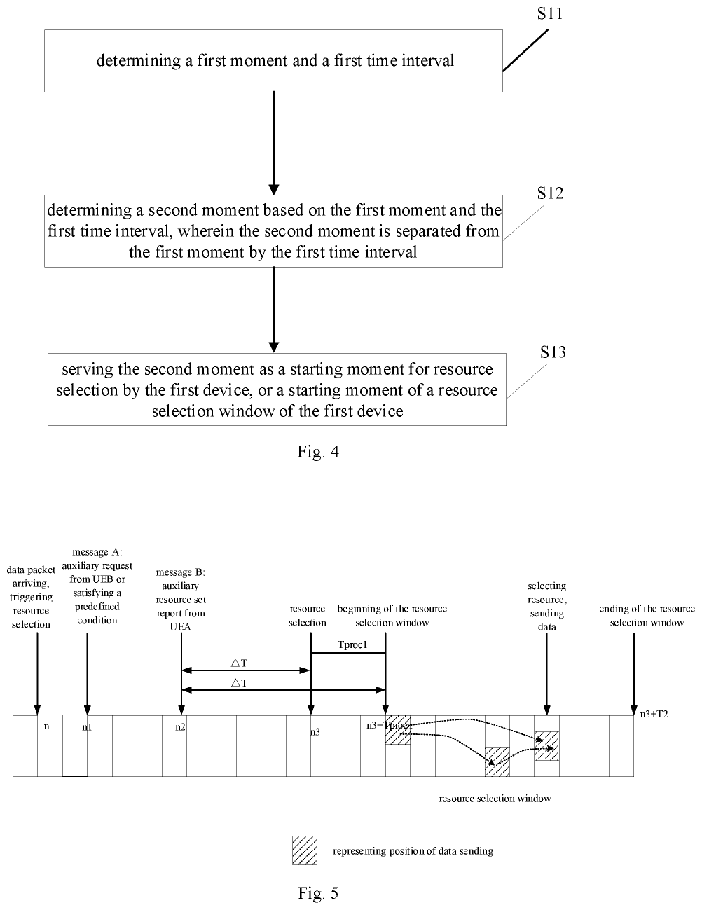

FIG. 4 is a flow chart of a resource selection method according to one example of the present disclosure. As shown in FIG. 4, the resource selection method includes the following steps.

In step S11, a first moment and a first time interval are determined.

In step S12, a second moment is determined based on the first moment and the first time interval, wherein the second moment is separated from the first moment by the first time interval.

In step S13, the second moment is served as a starting moment for resource selection by the first device, or a starting moment of a resource selection window of the first device.

In the examples of the present disclosure, the first moment may be understood as the starting moment when the first device determines the restricted time for restricting the resource selection time, i.e., the starting moment when the first device determines that the first time interval is reached.

In the examples of the present disclosure, the first time interval may be understood as a waiting period for forcing the first device to perform resource selection. In other words, after the first time interval elapses from the first moment, the first device is forced to perform resource selection. When the first device performs resource selection based on the first time interval, the auxiliary resource mechanism can be ignored and resource selection is performed directly, in a situation that a delay in resource selection is caused due to the auxiliary interaction process being too long, for example, waiting too long time for the second device to send auxiliary information. In this way, the delay caused by the resource selection by the first device using an auxiliary mechanism can be reduced.

In the resource selection method provided by the example of the present disclosure, the first time interval may be a predefined number of time slots in units of time slots. When it is determined that the first time interval is reached using the first moment as the starting moment, it can be determined that the time of the first time interval (the second moment) is reached when the number of time slots reaches the time slot corresponding to the number of time slots corresponding to the first time interval, using the first moment as the starting moment.

In the resource selection method provided in the examples of the present disclosure, the first time interval may also be an absolute time. For example, it can be the time in ms. When it is determined that the first time interval is reached using the first moment as the starting moment, it may be determined that the time corresponding to the first time interval is reached based on a timer. For example, a timer corresponding to the first time interval is started at the first moment, and the time when the timer reaches zero is determined as the time of reaching the first time interval (the second moment).

In the example of the present disclosure, when the first device performs resource selection based on the first moment and the first time interval, the moment separated from the first moment by the first time interval is regarded as the second moment, which can also be understood as the moment reaching the first time interval, served as a starting moment for resource selection by the first device, or a starting moment of a resource selection window of the first device, which may restrict the starting moment for the first device to start resource selection, so the delay caused by resource selection using the auxiliary mechanism can be improved.

In the resource selection method provided by the examples of the present disclosure, the first device performs resource selection based on the first moment and the first time interval, which can solve the problem of resource selection delay caused by too long auxiliary interaction process, such as waiting for the second device to send auxiliary information, during the auxiliary process with the second device, when the first device adopts the auxiliary mechanism to perform resource selection.

It can be understood that in the example of the present disclosure, the starting moment of the first time interval is the first moment, so the first time interval can be understood as the time difference between the first moment and the starting moment of resource selection by the first device, or may also be the time difference between the first moment and the starting moment of the resource selection window of the first device. Hereinafter, for convenience of description, the first time interval may be represented by ΔT. That is, in the example of the present disclosure, the time of ΔT is set for the first device to restrict the time of resource selection by taking the first moment as the starting moment. That is, resource selection must be performed when the time of ΔT is reached, to reduce the delay caused by the auxiliary resource selection mechanism between terminals as much as possible.

In the resource selection method provided by the examples of the present disclosure, the starting moment (first moment) used to restrict the first device to perform resource selection can be determined based on actual transmission requirements. For example, in the resource selection method provided by the example of the present disclosure, the first moment may be determined based on the auxiliary interaction process involved in the resource selection process by the first device using an auxiliary mechanism.

In one implementation, in order to avoid the situation where the first device waits for a long time for the completion of the auxiliary mechanism after the second device has received the resource auxiliary resource set report, the first moment can be set as the moment that the first device receives the auxiliary resource set report.

In one implementation, the starting moment (first moment) of the first time interval is the moment when the first device receives the resource auxiliary resource set report, and the end moment of the first time interval is the starting moment for resource selection by the first device, or the starting moment of a resource selection window of the first device.

FIG. 5 shows a schematic diagram of resource selection in an example of the present disclosure. Referring to FIG. 5, for example, the first device is UEB, and the second device is UEA. The first time interval for UEB to perform resource selection is ΔT. Referring to FIG. 5, the starting moment of ΔT can be the moment when the UEB receives the resource auxiliary resource set report (MsgB), and the ending moment of ΔT can be the starting moment of the resource selection by UEB, or the ending moment of ΔT may also be the starting moment of the resource selection window of UEB. That is, the maximum time difference between the time slots when the UEB receives the resource auxiliary resource set report and when the UEB performs resource selection is ΔT, or the maximum time difference between the time slot when the UEB receives the resource auxiliary resource set report and the time slot when the resource selection window begins is ΔT.

In one implementation, in order to avoid the situation where the first device does not receive the auxiliary resource set report of the second device and waits for a long time for the completion of the auxiliary mechanism after the first device has sent the resource auxiliary request, the first moment may be set as the moment when the first device sends the resource auxiliary request or the moment when it is determined that a predefined condition is met to trigger the second device to send custom conditions for the auxiliary resource set report information.

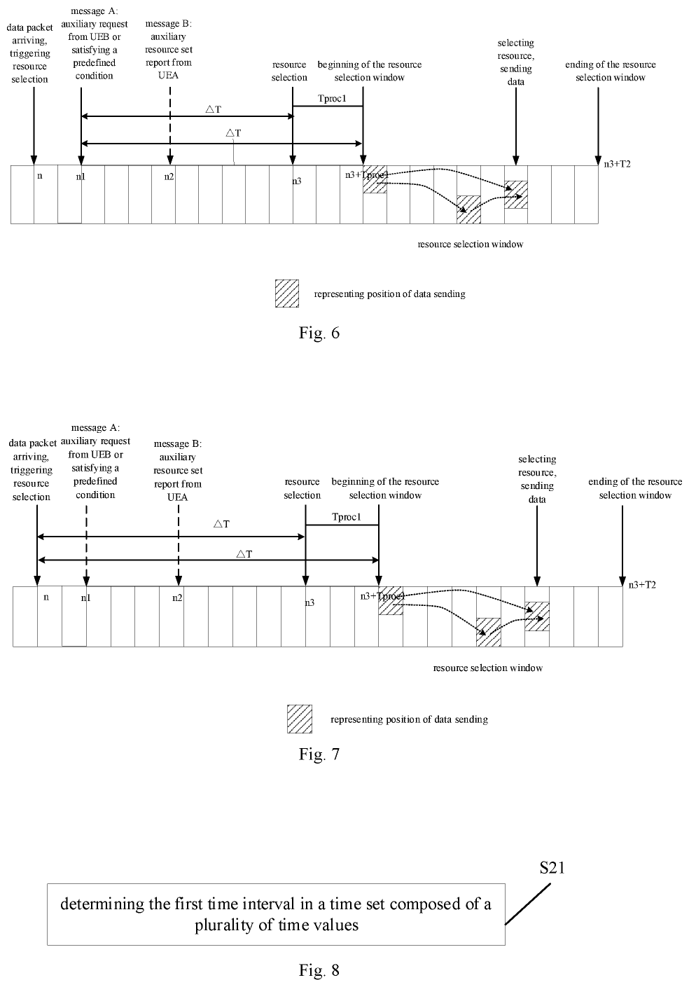

FIG. 6 shows a schematic diagram of resource selection in an example of the present disclosure. Referring to FIG. 6, for example, the first device is UEB, and the second device is UEA. The first time interval for UEB to perform resource selection is ΔT. Referring to FIG. 6, the starting moment of ΔT can be the moment when the UEB sends a resource auxiliary request or the moment when it is determined that the predefined condition is met to trigger the UEA to send custom conditions for the auxiliary resource set report information. The ending moment of ΔT can be the starting moment of the resource selection by UEB, or the ending moment of ΔT may also be the starting moment of the resource selection window of UEB. That is, the maximum time difference between the time slot when the UEB sends the auxiliary request (or the time slot when the UEB determines that the predefined condition is met) and the time slot when the UEB performs the resource selection is ΔT. Or the maximum time difference between the time slot when the UEB sends the auxiliary request (or the time slot when the UEB determines that the predefined condition is met) and the time slot when the resource selection window begins is ΔT.

In one implementation, in the example of the present disclosure, in order to avoid that the auxiliary mechanism cannot proceed normally, for example, the first device does not send the auxiliary request normally and waits for a long time for the auxiliary mechanism to be completed, the first moment can be set as the starting moment when the data packet received by the first device arrives and the first device is triggered to perform resource selection. For example, the first moment can be set as the starting moment when the data packet received by the first device arrives and the first device is triggered to perform resource selection.

FIG. 7 shows a schematic diagram of resource selection according to an example of the present disclosure. Referring to FIG. 7, the first device is UEB and the second device is UEA. The first time interval for UEB to perform resource selection is ΔT. Referring to FIG. 7, the starting moment of ΔT can be the starting moment when the data packet received by UEB arrives and UEB is triggered to perform resource selection, the ending moment of ΔT can be the starting moment of resource selection by UEB, or the ending moment of ΔT may also be the starting moment of the resource selection window of UEB. That is, the maximum time difference between the time slot when the data packet received by UEB arrives and UEB is triggered to perform resource selection and the time slot when UEB performs resource selection is ΔT, or the maximum time difference between the time slot when the data packet received by UEB arrives and UEB is triggered to perform resource selection and the time slot when the resource selection window begins is ΔT.

Referring to FIGS. 5 to 7 above, after the data packet of UEB arrives, after resource selection is triggered at the time slot n, the UEB sends message A (MsgA). In this example of the present disclosure, the UEB sends MsgA to the UEA, triggering the UEA to assist the UEB in resource selection. At the time slot n1, UEA receives MsgA from UEB. MsgA can be understood as a message in which UEB requests UEA to provide an auxiliary resource set. After receiving MsgA at the time slot n1, UEA can determine that UEB needs assistance, and then sends an auxiliary resource report MsgB to UEB at the time slot n2.

Referring to FIG. 5 to FIG. 7, it can be seen that in the example of the present disclosure, the UEB determines that the starting moment for resource selection based on the above set ΔT is n3. The starting moment n3 for resource selection by the UEB is no later than the ending moment of ΔT. n3+T2 is the ending position of the resource selection window. T2 is a fixed value. The 3GPP protocol stipulates that the value of T2 depends on the implementation capability of the user equipment, Tmin≤T2≤Packet Delay Budget (PDB).

Further, the UEB performs final resource selection at n3-Tproc1. The time of Tproc1 is the minimum time for preparing data packets after the UEB performs resource selection.

In the resource selection method provided in the examples of the present disclosure, the first time interval mentioned above may be understood as a time set composed of a plurality of time values. That is, ΔT is a time value in the time set composed of time values. The time set is pre-configured by Radio Resource Control (RRC).

In the resource selection method provided by the example of the present disclosure, when the first device performs resource selection, it can determine the first time interval in a time set composed of a plurality of time values, and perform resource selection based on the first moment and the first time interval.

FIG. 8 shows a flow chart of a resource selection method in an example of the present disclosure. Referring to FIG. 8, the resource selection method includes the following steps.

In step S21, a first time interval is determined in a time set composed of a plurality of time values.

In the embodiment of the present disclosure, when the first time interval is determined in a time set composed of a plurality of time values, it may be determined based on the data transmission requirements of the resource selection performed by the first device. In the existing mode2 resource selection, different PDB values are defined: sl-PacketDelayBudget-r16 INTEGER (0 . . . 1023), and different priorities are defined: a total of 8 priorities, P0 to P7.

For example, the data transmission requirement may be the priority and PDB value of transmitting data. That is, the first time interval may be determined based on the priority and PDB value of transmitting data by the first device. The higher the priority is, the smaller the PDB value is, and the smaller the value of the first time interval is.

In the resource selection method provided by the examples of the present disclosure, determining the first time interval in a time set composed of a plurality of time values includes at least one of following manners.

The first manner: based on a priority of data transmitted by the first device, the first time interval is determined in the time set composed of the plurality of time values. A first time interval corresponding to a first priority is smaller than a first time interval corresponding to a second priority, the first priority is higher than the second priority;

In an example, ΔT is a time set, which is determined by the priority of data transmitted by the first device at this time. The higher the priority is, the smaller the value of ΔT is.

The second manner: based on a data packet delay budget of data transmitted by the first device, the first time interval is determined in the time set composed of the plurality of time values. A first time interval corresponding to a first data packet delay budget is greater than a first time interval corresponding to a second data packet delay budget, a value of the first data packet delay budget is greater than a value of the second data packet delay budget.

In an example, ΔT is a time set, which is determined by the PDB value of the data transmitted by the first device at this time. The smaller the PDB is, the smaller the value of ΔT is.

The third manner: based on the priority and data packet delay budget of data transmitted by the first device, the first time interval is determined in the time set composed of the plurality of time values. A functional relationship exists between the first time interval, the priority and the packet delay budget of transmitting data.

In an example, ΔT is a time set, which is jointly determined by the priority and the PDB value of data transmitted by the first device at this time. ΔT satisfies a certain functional relationship with the priority and the PDB value.

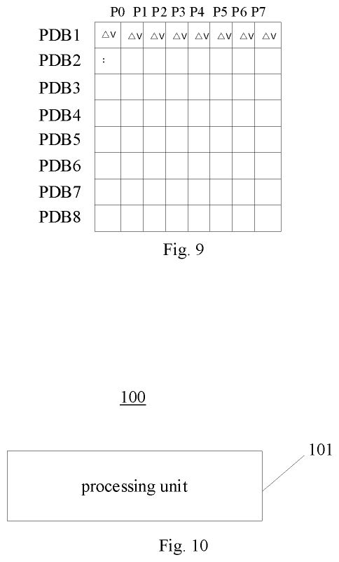

In the examples of the present disclosure, ΔT is determined based on the priority and/or PDB value of the data transmitted by the first device at this time. Different priorities and different PDB values determine different values of ΔT, based on the functional relationship between them three. For example, FIG. 9 shows a schematic diagram of the corresponding values between the ΔT value, priority and PDB value shown in an example of the present disclosure. In FIG. 9, P0, P1 . . . P7 represent priorities, and PDB1, PDB2 . . . PDB8 represent PDB values. Different priorities and different PDB values have different values of ΔT.

The fourth manner: based on a number of data repetitions by the first device, the first time interval is determined in the time set composed of the plurality of time values. A first time interval corresponding to a first number of repetitions is greater than a first time interval corresponding to a second number of repetitions, the first number of repetitions is smaller than the second number of repetitions

In an example, ΔT is a time value in a time set, which is determined by the number of repetitions. The greater the number of repetitions is, the smaller the value of ΔT is.

By setting a smaller first time interval in data transmission that requires a large number of repetitions, the delay can be reduced, repetition timeouts can be avoided, and the reliability of data transmission can be improved.

In the resource selection method provided by the example of the present disclosure, when an auxiliary mechanism is used for resource selection, the starting moment for starting resource selection is restricted, that is, resource selection must be performed when the restricted time is reached. Therefore, resource selection based on this restricted time can reduce the delay caused by using an auxiliary mechanism for resource selection.

It should be noted that those skilled in the art can understand that the various implementations/examples mentioned above in the examples of the present disclosure can be used in conjunction with the foregoing examples, or can be used independently. Whether used alone or in conjunction with the foregoing examples, the implementation principles are similar. In the implementation of the present disclosure, some examples are described using implementations used together. Those skilled in the art can understand that such illustrations do not limit the examples of the present disclosure.

Based on the same concept, examples of the present disclosure also provide a resource selection device.

It can be understood that, in order to implement the above functions, the resource selection device provided by the examples of the present disclosure includes hardware structures and/or software modules corresponding to each function. Combined with the units and algorithm steps of each example disclosed in the examples of the present disclosure, the examples of the present disclosure can be implemented in the form of hardware or a combination of hardware and computer software. Whether a function is performed by hardware or computer software driving the hardware depends on the specific application and design constraints of the technical solution. Those skilled in the art can use different methods to implement the described functions for each specific application, but such implementation should not be considered to go beyond the scope of the technical solutions of the examples of the present disclosure.

FIG. 10 is a block diagram of a resource selection device according to an example. Referring to FIG. 10, the resource selection device 100 includes a processing unit 101.

The processing unit 101 is configured to determine a first moment and a first time interval, and determine a second moment based on the first moment and the first time interval, wherein the second moment is separated from the first moment by the first time interval, and serve the second moment as a starting moment for resource selection by the first device, or a starting moment of a resource selection window of the first device.

In an example, the first moment indicates a moment when the first device receives an auxiliary resource set report.

In an example, the first moment indicates a moment for sending a resource auxiliary request by the first device, or a moment when a predefined condition is met to trigger the second device to send an auxiliary resource set report.

In an example, the first moment indicates a moment when a data packet of the first device arrives and the first device is triggered for resource selection.

In one example, the processing unit 101 is configured to determine the first time interval in a time set composed of a plurality of time values.

In one example, the processing unit 101 determines the first time interval in a time set composed of a plurality of time values by using at least one of following manners:
(i) based on a priority of data transmitted by the first device, determining the first time interval in the time set composed of the plurality of time values, wherein a first time interval corresponding to a first priority is smaller than a first time interval corresponding to a second priority, the first priority is higher than the second priority;
(ii) based on a data packet delay budget of data transmitted by the first device, determining the first time interval in the time set composed of the plurality of time values, wherein a first time interval corresponding to a first data packet delay budget is greater than a first time interval corresponding to a second data packet delay budget, a value of the first data packet delay budget is greater than a value of the second data packet delay budget;
(iii) based on the priority and data packet delay budget of data transmitted by the first device, determining the first time interval in the time set composed of the plurality of time values, wherein a functional relationship exists between the first time interval, the priority and the packet delay budget of transmitting data;
(iv) based on a number of data repetitions by the first device, determining the first time interval in the time set composed of the plurality of time values, wherein a first time interval corresponding to a first number of repetitions is greater than a first time interval corresponding to a second number of repetitions, the first number of repetitions is smaller than the second number of repetitions.

In one example, the time set is pre-configured by radio resource control signaling.

The technical solution provided by the examples of the present disclosure may include the following beneficial effects: determining the first moment and the first time interval, and determining the second moment. The second moment is separated from the first moment by a first time interval. The second moment is served as a starting moment for resource selection by the first device, or a starting moment of a resource selection window of the first device, such that when the first time interval is reached based on the first moment as the starting moment, resource selection is performed, or the starting moment of the resource selection window is started. Therefore, through the present disclosure, resource selection can be performed without waiting for the completion of the auxiliary process of using the auxiliary mechanism for resource selection, thereby reducing the delay caused by the first device using the auxiliary mechanism for resource selection.

Regarding the devices in the above examples, the specific manner in which each module performs operations has been described in detail in the examples related to the method, and will not be described in detail here.

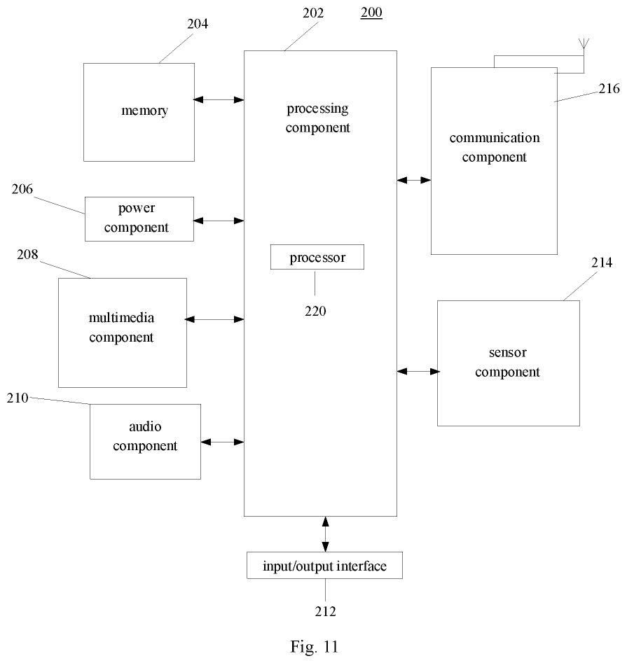

FIG. 11 is a block diagram of a resource selection device according to an example. For example, the device 200 may be a mobile phone, a computer, a digital broadcasting terminal, a messaging device, a gaming console, a tablet device, a medical device, a fitness device, a personal digital assistant, etc.

Referring to FIG. 11, the device 200 may include one or more of the following components: a processing component 202, a memory 204, a power component 206, a multimedia component 208, an audio component 210, an input/output (I/O) interface 212, a sensor component 214, and a communication component 216.

The processing component 202 typically controls the overall operations of the device 200, such as the operations associated with display, telephone calls, data communications, camera operations, and recording operations. The processing component 202 can include one or more processors 220 to execute instructions to perform all or part of the steps in the above methods. Moreover, the processing component 202 can include one or more modules to facilitate the interaction between the processing component 202 and other components. For example, the processing component 202 can include a multimedia module to facilitate the interaction between the multimedia component 208 and the processing component 202.

The memory 204 is configured to store various types of data to support the operation of the device 200. Examples of such data include instructions for any application or method operated on the device 200, such as the contact data, the phone book data, messages, pictures, videos, and the like. The memory 204 can be implemented by any type of volatile or non-volatile storage device, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic or optical disk.

The power component 206 provides power to various components of the device 200. The power component 206 can include a power management system, one or more power sources, and other components associated with generation, management, and distribution of power for the device 200.

The multimedia component 208 includes a screen providing an output interface between the device 200 and the user. In some examples, the screen may include a liquid crystal display (LCD) and a touch panel (TP). If the screen includes a touch panel, the screen may be implemented as a touch screen to receive input signals from the user. The touch panel includes one or more touch sensors to sense touches, swipes and gestures on the touch panel. The touch sensors may not only sense the boundaries of the touch or swipe action, but also detect the duration and pressure associated with the touch or swipe action. In some examples, the multimedia component 208 includes a front camera and/or a rear camera. When the device 200 is in an operation mode, such as a photographing mode or a video mode, the front camera and/or the rear camera can receive external multimedia data. Each of the front camera and the rear camera may be a fixed optical lens system or have focus and optical zoom capability.

The audio component 210 is configured to output and/or input an audio signal. For example, the audio component 210 includes a microphone (MIC) configured to receive an external audio signal when the device 200 is in an operation mode, such as a call mode, a recording mode, and a voice recognition mode. The received audio signal may be further stored in the memory 204 or sent via the communication component 216. In some examples, the audio component 210 also includes a speaker for outputting the audio signal.

The I/O interface 212 provides an interface between the processing component 202 and peripheral interface modules, such as a keyboard, a click wheel, buttons, and the like. These buttons may include, but not limited to, a home button, a volume button, a starting button, and a locking button.

The sensor component 214 includes one or more sensors for providing state assessments of various aspects of the device 200. For example, the sensor component 214 can detect an open/closed state of the device 200, relative positioning of components, such as the display and the keypad of the device 200. The sensor component 214 can also detect a change in position of one component of the device 200 or the device 200, the presence or absence of user contact with the device 200, an orientation, or an acceleration/deceleration of the device 200, and a change in temperature of the device 200. The sensor component 214 can also include a proximity sensor configured to detect the presence of nearby objects without any physical contact. The sensor component 214 can also include a light sensor, such as a CMOS or CCD image sensor, configured to use in imaging applications. In some examples, the sensor component 214 can also include an accelerometer sensor, a gyroscope sensor, a magnetic sensor, a pressure sensor, or a temperature sensor.

The communication component 216 is configured to facilitate communication between the device 200 and other devices by wired or wireless manners. The device 200 can access a wireless network based on a communication standard, such as Wi-Fi, 2G or 3G, or a combination thereof. In one example, the communication component 216 receives broadcast signals or broadcast associated information from an external broadcast management system via a broadcast channel. In one example, the communication component 216 also includes a near field communication (NFC) module to facilitate short-range communication. For example, the NFC module can be implemented based on radio frequency identification (RFID) technology, infrared data association (IrDA) technology, ultra-wideband (UWB) technology, Bluetooth (BT) technology and other technologies.

In one example, the device 200 may be implemented with one or more application specific integrated circuits (ASICs), digital signal processors (DSPs), digital signal processing devices (DSPDs), programmable logic devices (PLDs), field programmable Gate arrays (FPGAs), controllers, microcontrollers, microprocessors or other electronic components, to perform the methods described above.

In one example, there is also provided a non-transitory computer-readable storage medium including instructions, such as a memory 204 including instructions executable by the processor 220 of the device 200 to perform the above methods. For example, the non-transitory computer readable storage medium may be a ROM, a random access memory (RAM), a CD-ROM, a magnetic tape, a floppy disc, and an optical data storage device, or the like.

It can be further understood that “plurality” in this disclosure refers to two or more, and other quantifiers are similar. “And/or” describes the relationship between related objects, indicating that there can be three kinds of relationships. For example, A and/or B can mean: A exists alone, A and B exist simultaneously, and B exists alone. The character “/” generally indicates that the related objects are in an “or” relationship. The singular forms “a”, “the” and “said” are intended to include the plural forms as well, unless the context clearly indicates otherwise.

It is further understood that the terms “first”, “second”, etc. are used to describe various information, but such information should not be limited to these terms. These terms are only used to distinguish information of the same type from each other and do not imply a specific order or importance. In fact, expressions such as “first” and “second” can be used interchangeably. For example, without departing from the scope of the present disclosure, the first information may also be called second information, and similarly, the second information may also be called first information.

It will be further understood that although the operations are described in a specific order in the drawings in the examples of the present disclosure, this should not be understood as requiring that these operations be performed in the specific order shown or in a serial order, or that all the operations shown should be performed to obtain the desired results. In certain circumstances, multitasking and parallel processing may be beneficial.

Other implementations of examples of the present disclosure will be apparent to those skilled in the art from consideration of the specification and practice of the present disclosure disclosed herein. The present application is intended to cover any variations, uses, or adaptations of examples of the present disclosure, which are in accordance with the general principles of examples of the present disclosure and include common general knowledge or conventional technical means in the art that are not disclosed in examples of the present disclosure. The specification and examples are illustrative only, and the real scope and spirit of examples of the present disclosure is defined by the appended claims.

It should be understood that examples of the present disclosure are not limited to the precise structures that have been described above and shown in the drawings, and various modifications and changes can be made without departing from the scope thereof. The scope of examples of the present disclosure are limited only by the appended claims.

1. A resource selection method, applied to a first device, and the resource selection method comprising:
determining a first moment and a first time interval;
determining a second moment based on the first moment and the first time interval, wherein the second moment is separated from the first moment by the first time interval; and
serving the second moment as a starting moment for resource selection by the first device, or a starting moment of a resource selection window of the first device.

2. The resource selection method according to claim 1, wherein the first moment indicates a moment when the first device receives an auxiliary resource set report.

3. The resource selection method according to claim 1, wherein the first moment indicates a moment for sending a resource auxiliary request by the first device, or a moment when a predefined condition is met to trigger the second device to send an auxiliary resource set report.

4. The resource selection method according to claim 1, wherein the first moment indicates a moment when a data packet of the first device arrives and the first device is triggered for resource selection.

5. The resource selection method according to claim 1, wherein determining the first time interval comprises:
determining the first time interval in a time set composed of a plurality of time values.

6. The resource selection method according to claim 5, wherein determining the first time interval in a time set composed of a plurality of time values comprises at least one of following manners:
based on a priority of data transmitted by the first device, determining the first time interval in the time set composed of the plurality of time values, wherein a first time interval corresponding to a first priority is smaller than a first time interval corresponding to a second priority, the first priority is higher than the second priority;
based on a data packet delay budget of data transmitted by the first device, determining the first time interval in the time set composed of the plurality of time values, wherein a first time interval corresponding to a first data packet delay budget is greater than a first time interval corresponding to a second data packet delay budget, a value of the first data packet delay budget is greater than a value of the second data packet delay budget;
based on the priority and data packet delay budget of data transmitted by the first device, determining the first time interval in the time set composed of the plurality of time values, wherein a functional relationship exists between the first time interval, the priority and the packet delay budget of transmitting data;
based on a number of data repetitions by the first device, determining the first time interval in the time set composed of the plurality of time values, wherein a first time interval corresponding to a first number of repetitions is greater than a first time interval corresponding to a second number of repetitions, the first number of repetitions is smaller than the second number of repetitions.

7. The resource selection method according to claim 5, wherein the time set is pre-configured by radio resource control signaling.

8. A resource selection device, comprising:
a processor;
a memory for storing instructions executable by the processor;
wherein, the processor is configured to determine a first moment and a first time interval, and determine a second moment based on the first moment and the first time interval, wherein the second moment is separated from the first moment by the first time interval, and serve the second moment as a starting moment for resource selection by the first device, or a starting moment of a resource selection window of the first device.

9. The resource selection device according to claim 8, wherein the first moment indicates a moment when the first device receives an auxiliary resource set report.

10. The resource selection device according to claim 8, wherein the first moment indicates a moment for sending a resource auxiliary request by the first device, or a moment when a predefined condition is met to trigger the second device to send an auxiliary resource set report.

11. The resource selection device according to claim 8, wherein the first moment indicates a moment when a data packet of the first device arrives and the first device is triggered for resource selection.

12. The resource selection device according to claim 8, wherein the processor is further configured to determine the first time interval in a time set composed of a plurality of time values.

13. The resource selection device according to claim 12, wherein the processing unit determines the first time interval in a time set composed of a plurality of time values by using at least one of following manners:
based on a priority of data transmitted by the first device, determining the first time interval in the time set composed of the plurality of time values, wherein a first time interval corresponding to a first priority is smaller than a first time interval corresponding to a second priority, the first priority is higher than the second priority;
based on a data packet delay budget of data transmitted by the first device, determining the first time interval in the time set composed of the plurality of time values, wherein a first time interval corresponding to a first data packet delay budget is greater than a first time interval corresponding to a second data packet delay budget, a value of the first data packet delay budget is greater than a value of the second data packet delay budget;
based on the priority and data packet delay budget of data transmitted by the first device, determining the first time interval in the time set composed of the plurality of time values, wherein a functional relationship exists between the first time interval, the priority and the packet delay budget of transmitting data;
based on a number of data repetitions by the first device, determining the first time interval in the time set composed of the plurality of time values, wherein a first time interval corresponding to a first number of repetitions is greater than a first time interval corresponding to a second number of repetitions, the first number of repetitions is smaller than the second number of repetitions.

14. The resource selection device according to claim 12, wherein the time set is pre-configured by radio resource control signaling.

15-16. (canceled)

17. A non-transitory storage medium, having instructions stored therein, wherein the instructions in the storage medium enable a mobile terminal to execute a resource selection method when executed by a processor of the mobile terminal, wherein the resource selection method comprises:
determining a first moment and a first time interval;
determining a second moment based on the first moment and the first time interval, wherein the second moment is separated from the first moment by the first time interval; and
serving the second moment as a starting moment for resource selection by the first device, or a starting moment of a resource selection window of the first device.
